(19) United States
(12) Patent Application Publication
(10) Pub. No.: US 2021/0106867 A1
(43) Pub. Date: Apr. 15, 2021

(54) STATIONARY RECUMBENT BIKE THAT ARTICULATES

(71) Applicant: Kenneth Ray Washington, Lancaster, CA (US)

(72) Inventor: Kenneth Ray Washington, Lancaster, CA (US)

(21) Appl. No.: 16/598,819

(22) Filed: Oct. 10, 2019

(51) Int. Cl. A63B 22/06; A63B 24/00; A63B 21/00; A63B 71/06

(52) U.S. Cl. CPC A63B 22/0605; A63B 24/0087; A63B 21/4034; A63B 21/4035; A63B 71/0622; A63B 21/00069; A63B 2220/51; A63B 2022/0641; A63B 2022/0652; A63B 2208/0233; A63B 2024/009; A63B 2220/30; A63B 24/0062

(57) ABSTRACT

A stationary recumbent bike that can vary in both longitudinal and lateral angular displacement to simulate upward, downward, turning and leaning motions is disclosed. The disclosed recumbent bike comprises a seating section with a longitudinal axis frame, a pair of cycling pedals, a first actuator that provides longitudinal angular displacement for the seating section, a second actuator that provides lateral angular displacement for the seating section through a lateral axis frame, a processor that controls and synchronizes the first actuator and the second actuator based on simulated routes programmed and a power supply for supplying power to the first actuator, the second actuator and the processor.

### FIELD OF THE INVENTION

The present invention pertains to a stationary recumbent bike in general, and more specifically to an articulating stationary recumbent bike that is capable of varying in both longitudinal and lateral angular displacement to simulate up hill, downhill and turning environments.

### BACKGROUND OF THE INVENTION

Exercise bikes are often referred to as stationary bicycles or stationary recumbent bikes. In recent years, they have gained rising popularity and many people get drawn to the idea of purchasing an exercise bike to work out indoors. Working out on an exercise bike is great for weight loss and toning and provides users with many beneficial health effects. Also, they will help to improve users' fitness levels.

Unfortunately, riding stationary bikes can get monotonous after some while. Many users find it boring to pedal on an exercise bike for a period of time and their indoor exercise biking will eventually get cut short by boredom.

To solve this problem, in U.S. Pat. No. 7,081,070 (the '070 Patent), the inventor of the present invention disclosed an articulating platform that is used to vary the longitudinal and lateral angular displacement of an exercise bicycle mounted thereon. The platform includes a bicycle mounting base configured to accept the footprint of a conventionally dimensioned exercise bicycle. The base pivots in both a longitudinal axis and a lateral axis, thereby simulating uphill and downhill bicycle riding and turning when leaning sideways in a turning direction. The 070′ Patent has effectively made exercise bike riding less monotonous through changing angular displacement of the exercise bike.

However, while the '070 Patent provides simulated bicycle ridings for conventional exercise bikes, the design may not be suitable for all users. For examples, users with disabilities, users undergoing rehabilitations (i.e., injured veterans) and users not tall enough may find these exercise bikes difficult to access and mount on because the disclosed articulating platform will increase the height of these exercise bikes. Furthermore, the distance between the seat section and pedal section for most conventional exercise bikes are adjusted by changing the height of the seat section (i.e., through the adjustable seatpost), which makes the seat section of these exercise bikes even higher above the ground when these exercise bikes are mounted on the disclosed platform and ridden by people with long legs.

Another drawback of the '070 Patent is it provides angular displacement for the mounted exercise bike from the bottom. Users sitting on top of the mounted exercise bike may experience larger tilting motions when the mounted exercise bike is tall (i.e., users are further away from the axis of rotation at bottom), making the riding simulation to feel less natural and comfortable. Also, most conventional exercise bikes put main components of the bike such as the main frames, stabilizer, handlebar, belt, motor and/or flywheel etc. in front of the user and/or in proximity to the leg area of the user, making it difficult for some users to mount on the exercise bikes and leave very little room for user's legs to stretch.

Accordingly, there exists a need for an improved exercise bike that not only can simulate actual bicycle ride, but also can be accessed easily by people with disabilities or undergoing rehabilitation and people who are not tall enough. There also exists a need for an improved articulating exercise bike that provides angular displacement of a user in proximity to the user's body, making the user to feel more natural and comfortable tilting motions. There also exists a need for an improved exercise bike design that optimize spaces available around user's leg area to provide the user with ultimate comfort during riding.

### SUMMARY OF THE DISCLOSURE

The major objective of the present disclosure is to provide a stationary recumbent bike that articulates and is configured to be easily accessible by people with disabilities.

Another objective of the present disclose is to provide a stationary recumbent bike that provides angular displacement of a user in proximity to the user by making axis of rotation as close to user as possible.

Yet another objective of the present disclosure is to provide a stationary recumbent bike that optimize spaces available around user's leg area to provide the user with ultimate comfort during riding.

In accordance with one aspect of at least one embodiment of the present disclosure, a stationary recumbent bike that articulates is disclosed comprising: 1) a seating section with a first supporting frame; 2) a pair of cycling pedals that is connected to the seating section; 3) a first actuator that rotates the seating section in vertical (x-axis) direction and its axis of rotation is configured to locate in proximity to the seating section's center; 4) a second actuator that rotates the seating section in horizontal (y-axis) direction through a second supporting frame and its axis of rotation is configured to locate in proximity to the seating section's center; 5) a processor that connects to the first actuator, the second actuator, wherein the processer controls movements of the first actuator and the second actuator based on simulated routes programmed; 6) a display system for providing a visual display, where the display system is programmed to display scenic views relative to the simulated routes; and 7) a power supply for supplying power to the first actuator, the second actuator, the processor and the display system. The disclosed stationary recumbent bike may further comprise a pedal resistance mechanism coupled to the pair of cycling pedals for providing pedal resistance to the user.

In one embodiment, the simulated routes are paths comprising different elevations and turns. For examples, they may be roads with uphill, downhill and turns, or flight paths (e.g., on air or in space) with ascending, descending and turns. The processor is programmed to control and synchronize the first actuator, the second actuator to provide appropriate angular movements for the seating section to correspond with views displayed by the display system. For examples, the processor will cause the first actuator to rotate the seating section and the pair of cycling pedals in vertical direction to simulate upward and downward motion shown in the visual display, and cause the second actuator to rotate the seating section and the pair of cycling pedals in horizontal direction to simulate turning and leaning motion shown in the visual display.

In yet another embodiment, the second actuator and part of the second supporting frame are arranged to locate behind the seating section and the second actuator and the second supporting frame are configured to hold the seating section and the pair of cycling pedals in the air and above the ground. Such design optimizes spaces available around user's leg area to provide the user with ultimate comfort during riding, and also keeps the seating section relatively low to the ground allowing user to access the seating section more easily.

In yet another embodiment, the disclosed stationary recumbent bike further comprises a housing that encloses the second actuator and the processor and a bottom supporting member that connects the housing to the visual display, where the bottom supporting member is located beneath the seating section and the pair of cycling pedals.

The foregoing and other objects, features and advantages of the present invention are more readily apparent from the detailed description of the preferred embodiments set forth below, taken in conjunction with the accompanying drawings.

### BRIEF DESCRIPTION OF THE DRAWINGS

FIG. 1 is a schematic drawing according to an exemplary embodiment of the present invention.

FIG. 2 is a schematic drawing according to an exemplary embodiment of the present invention.

FIG. 3 is a schematic drawing according to an exemplary embodiment of the present invention.

FIG. 4 is a schematic drawing according to an exemplary embodiment of the present invention.

FIG. 5 is a schematic drawing according to an exemplary embodiment of the present invention.

FIG. 6 is a schematic drawing according to an exemplary embodiment of the present invention.

### DETAILED DESCRIPTION OF PREFERRED EMBODIMENTS

The following description is not to be taken in a limiting sense, but is made merely for the purpose of illustrating the general principles of the invention, since the scope of the invention is best defined by the following claims. Various inventive features are described below that can each be used independently of one another or in combination with other features.

Broadly, embodiments of the present disclosure generally provide a stationary recumbent bike in general, and more specifically to an articulating stationary recumbent bike that is capable of varying in both longitudinal and lateral angular displacement to simulate upward, downward and turning motions.

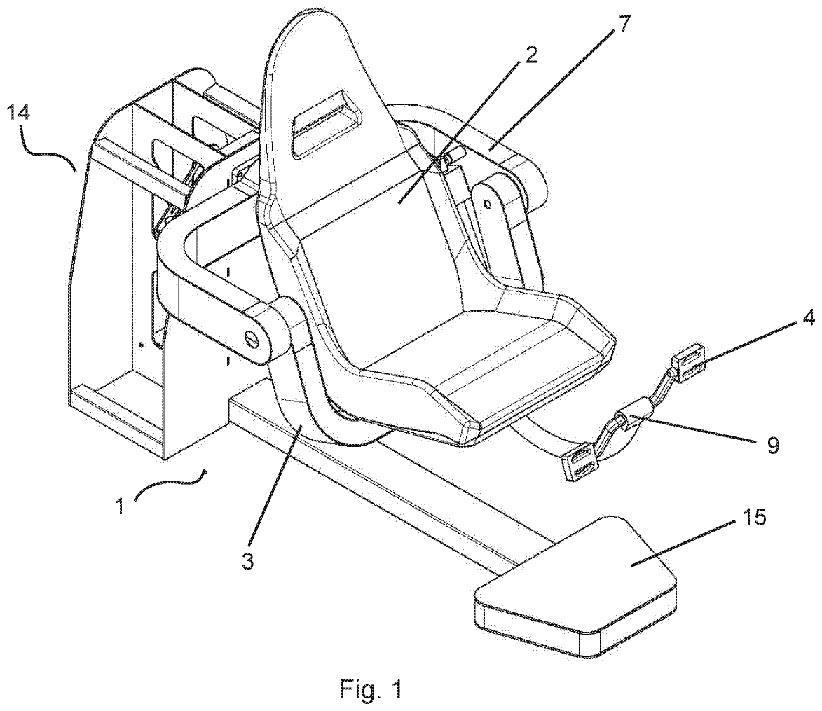

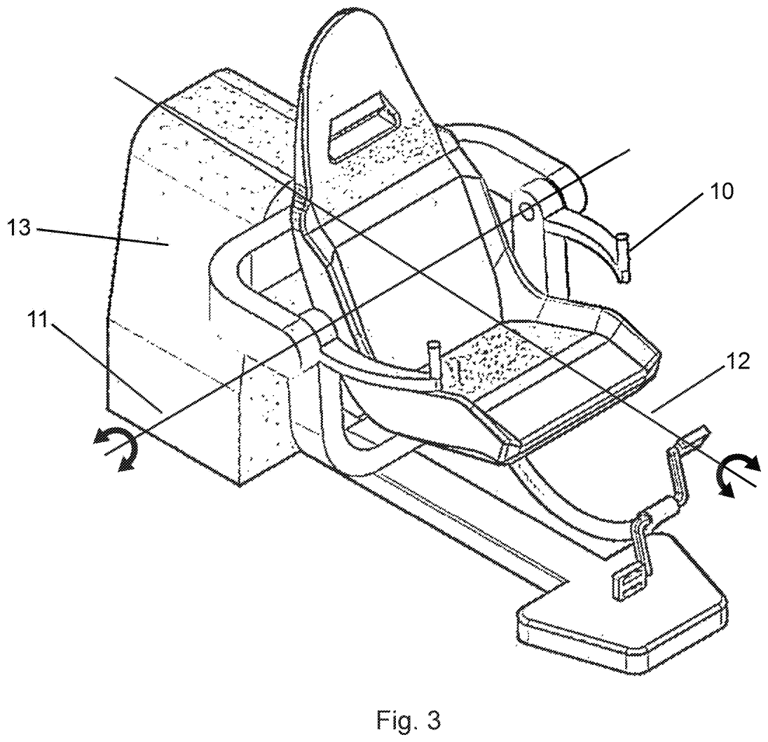

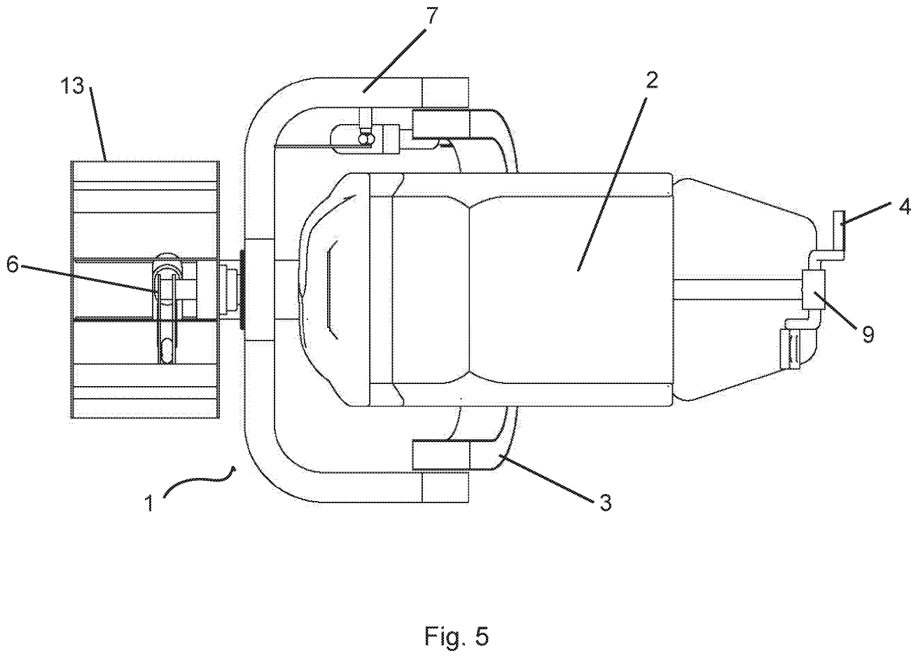

In accordance with one aspect of at least one embodiment of the present disclosure, as shown by FIGS. 1, 2 and 5, the disclosed stationary recumbent bike 1 comprises a seating section 2 with a first supporting frame 3 (may also be referred as “longitudinal axis frame” throughout the disclosure), a pair of cycling pedals 4 that is connected to the seating section 2, a first actuator 5 (e.g., x-axis actuator) that provides longitudinal angular displacement for the seating section 2 (i.e., rotates the seating section 2 in vertical (x-axis) direction), a second actuator 6 that provides lateral angular displacement for the seating section 2 through a second supporting frame 7 (may also be referred as “lateral axis frame” throughout the disclosure which rotates the seating section in horizontal (y-axis) direction), a processor 8 that connects to the first actuator 5, the second actuator 6, wherein the processer 8 controls movements of the first actuator 5 and the second actuator 6 based on simulated routes programmed and a power supply (not shown in Figures) for supplying power to the first actuator 5, the second actuator 6 and the processor 8. In general, the programmed simulated routes are paths comprising different elevations and turns and the processor 8 is configured to control and synchronize the first actuator 5 and the second actuator 6 to provide appropriate angular movements for the seating section 2 based on the simulated routes. The stationary recumbent bike 1 may further comprise a pedal resistance mechanism 9 coupled to the pair of cycling pedals 4 for providing pedal resistance to the user. There would also be a sensor (not shown in Figures) within or in proximity to the pair of cycling pedals 4 or the pedal resistance mechanism 9 for detecting the force and/or speed a user applies on the pair of cycling pedals 4 and/or for detecting/counting number of turns the pair of cycling pedals 4 has turned (e.g., for processor 8 to calculate distance pedaled by the user). In other words, the processor 8 will calculate and determine a user's progress in the simulated routes based at least in part on the force and speed the user applied on the pair of cycling pedals 2 and/or pedals' 2 number of turns. The seating section 2 may further comprise a pair of gripping handles 10 as shown by FIG. 3. Also, the pair of cycling pedals 4 can be designed to extendably connect to the seating section 2 so the distance between the pair of cycling pedals 4 and the seating section 2 can be adjusted to accommodate different lengths of legs. The first actuator 5 and the second actuator 6 can be driven by electric and/or pneumatic and/or hydraulic drive attached to the axis frames.

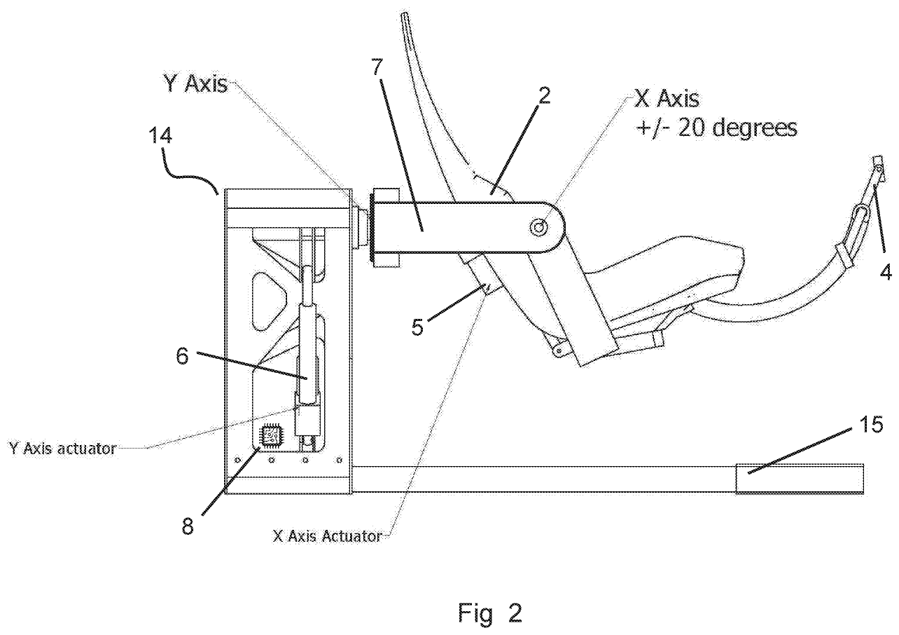

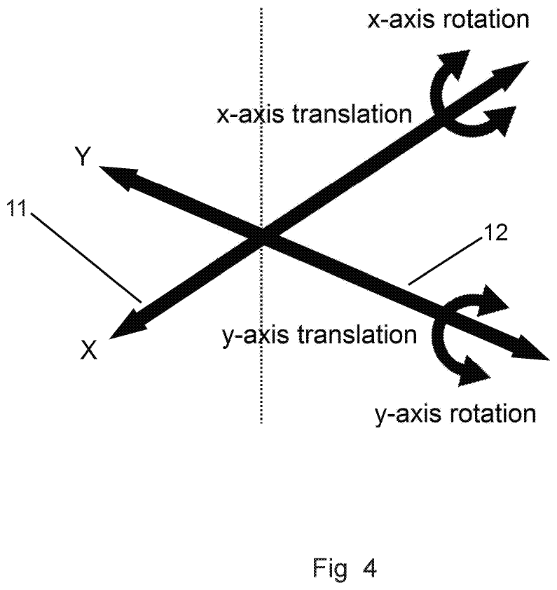

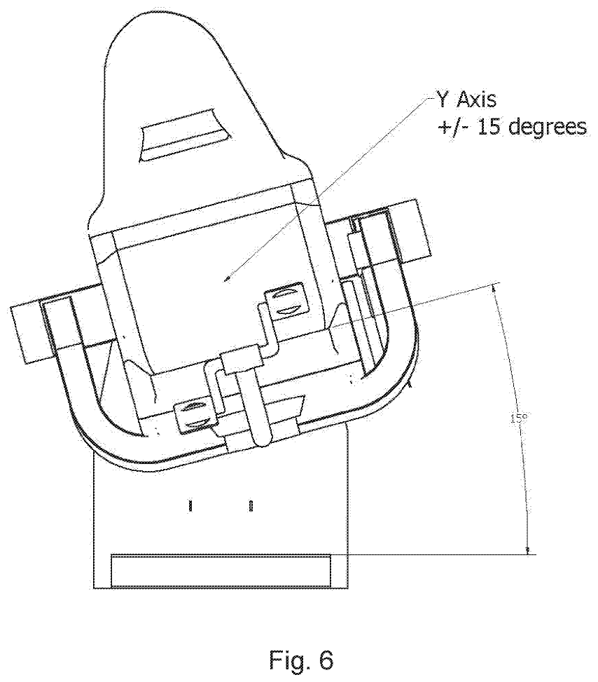

In one embodiment, as shown by FIGS. 2 to 4 and 6, the x-axis of rotation 11 for the seating section 2 is designed to locate in proximity to the center of the seating section 2, where the rotation is actuated by the first actuator 5 and through the first supporting frame 3. Similarly, the y-axis of rotation 12 for the seating section is designed to locate in proximity to the center of the seating section 2 as well, where the rotation is actuated by the second actuator 6 and through the second supporting frame 7. Since axis (11, 12) of rotation for vertical and lateral directions are in proximity to the seating section 2, this provides angular displacement of a user in proximity to the user's body when the user is sitting on the seating section 2, thereby making the user to feel more natural and comfortable tilting motions (e.g., uphill, downhill, turning and leaning etc.). The second supporting frame 7 can optionally be configured to attach the first supporting frame 3 at x-axis of rotation 11 as shown by the Figure. The longitudinal axis frame (e.g., first supporting frame 3) and the lateral axis frame (e.g., second supporting frame 7) can run simultaneously or independently configured to accept an upright seat to simulate a stationary recumbent bicycle riding uphill, downhill, turning right and left with simulated pedal resistance.

In yet another embodiment, the second actuator 6 and the second supporting frame 7 are arranged to locate behind the seating section 2 and are configured to hold the seating section 2, the pair of cycling pedals 4 and the first actuator 5 in the air and above the ground as shown by the Figure. Such configuration optimizes spaces available around user's leg area and provides the user with ultimate comfort while riding the bike 1.

In yet another embodiment of the present disclosure, the stationary recumbent bike 1 further comprises a display system for providing a visual display (e.g., through LCD screen). The display system is programmed to display simulated scenic views relative to the simulated routes. For examples, scenic views may be bicycle riding views, airplane or spaceship flight views or underwater submarine views. The processor 8 is also configured to control and synchronize the first actuator 5 and the second actuator 6 to provide appropriate angular movements for the seating section 2 to correspond with views displayed by the display system. For example, the processor 8 and the visual system can simulate bicycle rider scenic views relative to the articulating recumbent bike's 1 position. Recorded images will be displayed by the display system on a screen in front of the user riding the bike 1, such as showing a road that has hills and curves. The processor 8 would synchronize the appropriate angular movements of the bike 1 (or the seating section 2) to correspond with the view of the road on the screen. For examples, the processor 8 will simulate uphill and downhill bicycle riding by causing the longitudinal angular displacement of the seating section 2 to change and simulates bicycle turning and leaning motion by causing the lateral angular displacement of the seating section 2 to change.

In yet another embodiment of the present disclosure, as shown by FIG. 3, the stationary recumbent bike 1 has a housing 13 that encloses at least the second actuator 6 and the processor 8 for safety and/or aesthetic purpose. The housing 13 may also serve as or include a back stabilizer 14 as shown by FIGS. 1 and 2. The stationary recumbent bike 1 may further comprise a bottom supporting member (e.g., bottom stabilizer 15) that connects to the housing 13 (and perhaps connects the housing 13 to the display system as well if there is one), where the bottom supporting member is located beneath the seating section 2 and the pair of cycling pedals 4. The back stabilizer 14 and bottom stabilizer 15 provide stability to the bike 1 by having sufficient weight to hold down the bike 1 and they are configured to prevent the whole bike 1 from moving or tilting. Preferably, the processor 8 is located within the back stabilizer 14 (e.g., within the housing 13) as well. The housing 13 along with the back stabilizer 14 and bottom stabilizer 15 function as a base unit that is the foundation of the bike 1 structure (holds bike 1 in place and stabilizes the bike 1). The housing 13 also houses electronics and/or pneumatics and/or hydraulics for function of the articulating stationary recumbent bicycle 1.

In yet another embodiment of the present disclosure, the stationary recumbent bike 1 may further comprise a manual control for controlling movements of the first actuator 5 and the second actuator 6. This may be an electronic interface in proximity to one or both hand grips 10 and/or on a base unit smartphone docking station. The rider will place his smartphone in the docking station, which can be located close to hand grips 10 section or somewhere on the back stabilizer 14 (e.g., the housing 13 part), which will energize the bike and/or the rider can download Built2Move app. The app will have 21 programmable rides from Novice to Professional which will include banking left/right/uphill/downhill with resistance. The manual control can be used for initiating directional articulation for the seating section 2. The hand grips 10 could also contain unique controls for manipulations of graphical user interface, television screen, entertainment system or a wireless keyboard. For examples, the hand grips will allow the rider to increase/decrease resistance, answer the phone, access the net, view private channels (while exercising, the rider can study plays, teams and trainers' regiment), and in manual mode (with or without an umbilical cord/remote to be manipulated by the trainer) maintain a certain position/resistance/uphill/downhill. The trainer will be able to download vitals and monitor the rider's work-out regiment. The hand grips 10 could also be configured to have a shape of basketballs, volleyballs, golf balls etc. so that the disclosed bike 1 can also be used as a gaming chair.

In yet another embodiment of the present disclosure, the disclosed bike 1 can also be used as a game chair. For examples, the bike's pedaling system will lock in place. The right pedal will be the gas and the left pedal will be the brakes and of course the hand grips will become the steering, the top of the hand grip will the firing mechanism and squeezing the grips can launch missiles.

In yet another embodiment of the present disclosure, a stationary recumbent bike that articulates is disclosed. The stationary recumbent bike comprises a seating section with a first supporting frame; a pair of cycling pedals that is connected to the seating section; a pedal resistance mechanism coupled to the pair of cycling pedals for providing pedal resistance to the user; a first actuator that rotates the seating section in vertical (x-axis) direction and its axis of rotation is configured to locate in proximity to the seating section's center; a second actuator that rotates the seating section in horizontal (y-axis) direction through a second supporting frame and its axis of rotation is configured to locate in proximity to the seating section's center; wherein the second actuator and the second supporting frame are configured to hold the seating section and the pair of cycling pedals in the air and above the ground; a processor that connects to the first actuator, the second actuator and the pedal resistance mechanism, wherein the processer controls movements of the first actuator and the second actuator and the pedal resistance of the pair of cycling pedals based on simulated routes programmed; a display system for providing a visual display, where the display system is programmed to display bicycle rider scenic views relative to the simulated routes; wherein the simulated routes are paths comprising different elevations and turns, and the processor controls and synchronizes the first actuator, the second actuator to provide appropriate angular movements for the seating section to correspond with views displayed by the display system; a power supply for supplying power to the first actuator, the second actuator, the pedal resistance mechanism, the processor and the display system; and wherein the second actuator is arranged to locate behind the seating section. The stationary recumbent bike may further comprise a housing that encloses the second actuator and the processor and a bottom supporting member that connects the housing to the visual display, wherein the bottom supporting member is located beneath the seating section and the pair of cycling pedals. The processor is configured to cause the first actuator to rotate the seating section and the pair of cycling pedals in vertical direction to simulate upward and downward motion shown in the visual display, and causes the second actuator to rotate the seating section and the pair of cycling pedals in horizontal direction to simulate turning and leaning motion shown in the visual display.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should also be noted that when the term “a”, “an”, etc. is used, it is to be interpreted as “at least one” throughout the application, drawings, and claims. Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

A portion of the disclosure of this patent document including any priority documents contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A stationary recumbent bike that articulates, the stationary recumbent bike comprising:
a seating section with a first supporting frame;
a pair of cycling pedals that is connected to the seating section;
a pedal resistance mechanism coupled to the pair of cycling pedals for providing pedal resistance to the user;
a first actuator that provides longitudinal angular displacement for the seating section;
a second actuator that provides lateral angular displacement for the seating section through a second supporting frame;
a processor that connects to the first actuator, the second actuator and the pedal resistance mechanism, wherein the processer controls movements of the first actuator and the second actuator and the pedal resistance of the pair of cycling pedals based on simulated routes programmed; and
a power supply for supplying power to the first actuator, the second actuator, the pedal resistance mechanism and the processor.

2. The stationary recumbent bike of claim 1, wherein the seating section or the first supporting frame further comprises a pair of gripping handles.

3. The stationary recumbent bike of claim 1 further comprises a housing that encloses the second actuator and the processor.

4. The stationary recumbent bike of claim 1, wherein the second actuator and the second supporting frame are arranged to locate behind the seating section and are configured to hold the seating section and the pair of cycling pedals in the air and above the ground.

5. The stationary recumbent bike of claim 1 further comprises a display system for providing a visual display.

6. The stationary recumbent bike of claim 5, wherein the display system is programmed to display simulated scenic views relative to the simulated routes.

7. The stationary recumbent bike of claim 1 further comprises a manual control for controlling movements of the first actuator and the second actuator.

8. The stationary recumbent bike of claim 6 further comprises a housing that encloses the second actuator and the processor and a bottom supporting member that connects the housing to the visual display, wherein the bottom supporting member is located beneath the seating section and the pair of cycling pedals.

9. The stationary recumbent bike of claim 6, wherein the processor calculates and determines a user's progress in the simulated routes based in part on force and speed the user applied on the pair of cycling pedals or number of turns the pair of cycling pedals has turned.

10. The stationary recumbent bike of claim 1, wherein the first actuator that rotates the seating section in vertical direction is configured to have its axis of rotation locates in proximity to the seating section's center and the second actuator that rotate the seating section in horizontal direction is configured to have its axis of rotation locate in proximity to the seating section's center.

11. A stationary recumbent bike that articulates, the stationary recumbent bike comprising:
a seating section with a first supporting frame;
a pair of cycling pedals that is connected to the seating section;
a pedal resistance mechanism coupled to the pair of cycling pedals for providing pedal resistance to the user;
a first actuator that rotates the seating section in vertical direction;
a second actuator that rotates the seating section in horizontal direction through a second supporting frame;
wherein the second actuator and the second supporting frame are configured to hold the seating section and the pair of cycling pedals in the air and above the ground;
a processor that connects to the first actuator, the second actuator and the pedal resistance mechanism, wherein the processer controls movements of the first actuator and the second actuator and the pedal resistance of the pair of cycling pedals based on simulated routes programmed;
a display system for providing a visual display, where the display system is programmed to display bicycle rider scenic views relative to the simulated routes;
a power supply for supplying power to the first actuator, the second actuator, the pedal resistance mechanism, the processor and the display system; and
wherein the second actuator is arranged to locate behind the seating section.

12. The stationary recumbent bike of claim 11 further comprises a manual control for controlling movements of the first actuator and the second actuator.

13. The stationary recumbent bike of claim 11 further comprises a housing that encloses the second actuator and the processor and a bottom supporting member that connects the housing to the visual display, wherein the bottom supporting member is located beneath the seating section and the pair of cycling pedals.

14. The stationary recumbent bike of claim 11, wherein the processor calculates and controls a user's progress in the simulated routes based in part on force and speed the user applied on the pair of cycling pedals.

15. The stationary recumbent bike of claim 11, wherein the simulated routes are paths comprising different elevations and turns, and the processor controls and synchronizes the first actuator, the second actuator to provide appropriate angular movements for the seating section to correspond with views displayed by the display system.

16. The stationary recumbent bike of claim 11, wherein the processor causes the first actuator to rotate the seating section and the pair of cycling pedals in vertical direction to simulate uphill and downhill bicycle riding shown in the visual display, and causes the second actuator to rotate the seating section and the pair of cycling pedals in horizontal direction to simulate bicycle turning and leaning motion shown in the visual display.

17. The stationary recumbent bike of claim 11, wherein the pair of cycling pedals is extendably connected to the seating section and is configured to be movable toward or away from the seating section.

18. A stationary recumbent bike that articulates, the stationary recumbent bike comprising:
a seating section with a first supporting frame;
a pair of cycling pedals that is connected to the seating section;
a pedal resistance mechanism coupled to the pair of cycling pedals for providing pedal resistance to the user;
a first actuator that rotates the seating section in vertical direction and its axis of rotation is configured to locate in proximity to the seating section's center;
a second actuator that rotates the seating section in horizontal direction through a second supporting frame and its axis of rotation is configured to locate in proximity to the seating section's center;
wherein the second actuator and the second supporting frame are configured to hold the seating section and the pair of cycling pedals in the air and above the ground;
a processor that connects to the first actuator, the second actuator and the pedal resistance mechanism, wherein the processer controls movements of the first actuator and the second actuator and the pedal resistance of the pair of cycling pedals based on simulated routes programmed;
a display system for providing a visual display, where the display system is programmed to display bicycle rider scenic views relative to the simulated routes;
wherein the simulated routes are paths comprising different elevations and turns, and the processor controls and synchronizes the first actuator, the second actuator to provide appropriate angular movements for the seating section to correspond with views displayed by the display system;
a power supply for supplying power to the first actuator, the second actuator, the pedal resistance mechanism, the processor and the display system; and
wherein the second actuator is arranged to locate behind the seating section.

19. The stationary recumbent bike of claim 18 further comprises a housing that encloses the second actuator and the processor and a bottom supporting member that connects the housing to the visual display, wherein the bottom supporting member is located beneath the seating section and the pair of cycling pedals.

20. The stationary recumbent bike of claim 18, wherein the processor causes the first actuator to rotate the seating section and the pair of cycling pedals in vertical direction to simulate upward and downward motion shown in the visual display, and causes the second actuator to rotate the seating section and the pair of cycling pedals in horizontal direction to simulate turning and leaning motion shown in the visual display.
